(19) United States
(12) Patent Application Publication
(10) Pub. No.: US 2026/0228153 A1
(43) Pub. Date: Aug. 6, 2026

(54) INTERCONNECTION SYSTEM COMPRISING A PLURALITY OF COMPUTING MODULES AND COMPUTING SYSTEM

(71) Applicant: SHANGHAI XIZHI TECHNOLOGY CO., LTD., Shanghai (CN)

(72) Inventors: Yichen SHEN, Shanghai (CN); Huaiyu MENG, Shanghai (CN); Wu ZHOU, Shanghai (CA); Jun XIONG, Shanghai (CN); Azhar HUSSAIN, Shanghai (CN); Jian ZHU, Shanghai (CN)

(21) Appl. No.: 19/633,915

(22) Filed: Mar. 30, 2026

Related U.S. Application Data
(63) Continuation of application No. PCT/CN2025/088046, filed on Apr. 9, 2025.

(30) Foreign Application Priority Data
Apr. 28, 2024 (CN) 202410530040.0

(51) Int. Cl. G06F 13/40

(52) U.S. Cl. CPC G06F 13/40

(57) ABSTRACT

The present disclosure relates to an interconnection system comprising a plurality of computing modules, and to a computing system including the same. The plurality of computing modules are hierarchically organized into multiple levels of computing module groups. In the hierarchical structure, a plurality of computing modules form first-level computing module groups, a plurality of first-level computing module groups form second-level computing module groups, and additional higher-level computing module groups may be formed in a similar hierarchical manner, thereby constructing two or more levels of computing module groups. For each level, a number of input/output interfaces used for communication interconnection within computing module groups at that level is greater than a number of input/output interfaces used for communication interconnection between different computing module groups at that level.

### CROSS-REFERENCE TO RELATED APPLICATION(S)

This application claims priority to Chinese Patent Application No. 2024105300400, entitled “Interconnection System Comprising a Plurality of Computing Modules and Computing System,” filed on Apr. 28, 2024, the entire disclosure of which is incorporated herein by reference.

### FIELD OF THE INVENTION

The present disclosure relates to the field of computer technology, and more particularly, to an interconnection system comprising a plurality of computing modules and to a computing system including the interconnection system.

### BACKGROUND OF THE INVENTION

According to publicly available information from the American artificial intelligence research organization OpenAI, the growth rate of computational demand for artificial intelligence (AI) models has significantly exceeded the improvement rate of computing hardware performance. As AI accelerators continue to improve in performance through advances in semiconductor process technologies and chip architecture innovations, the required interconnection bandwidth between AI accelerators has also continued to increase. Consequently, AI accelerator interconnection networks have become an important factor affecting the overall computational capability of computing systems.

However, as signal transmission rates increase, the response characteristics of electrical channels deteriorate due to signal attenuation. Higher-rate electrical interfaces typically require more complex architectures and circuit designs, which may introduce additional latency, increase power consumption, and occupy larger chip areas, thereby limiting the available input/output bandwidth of the chip. In addition, longer metal interconnect distances further degrade signal integrity and increase transmission losses, which limits the feasible interconnection distance between AI accelerators.

To overcome the limitations associated with long-distance and high-frequency electrical interconnections, optical interconnection has been considered a promising technical approach. Although optical interconnection can alleviate distance limitations, the number of interfaces available at each computing node remains limited. Accordingly, there is a need to utilize the limited interfaces to design an effective interconnection topology that enables a computing cluster to satisfy the requirements for both high computational capability and high bandwidth.

### SUMMARY OF THE INVENTION

In one aspect, an interconnection system for a plurality of computing modules is provided. The interconnection system comprises a plurality of computing modules, each computing module having K input/output interfaces, wherein K is an integer greater than 0. The plurality of computing modules being hierarchically organized into j levels of computing module groups, wherein j is an integer greater than or equal to 2. Every N1 computing modules form a first-level computing module group, and M1 input/output interfaces of each computing module are used for communication interconnection among the computing modules within the first-level computing module group, the computing modules within the first-level computing module group being communicatively interconnected through first links, and N1 is an even integer greater than or equal to 2; every Ni computing module groups of the (i−1)th-level form an ith-level computing module group, and Mi input/output interfaces of each (i−1)th-level computing module group are used for communication interconnection among the (i−1)th-level computing module groups within the ith-level computing module group, the (i−1)th-level computing module groups within the ith-level computing module group being communicatively interconnected through ith links, where i denotes a level index satisfying 1<i≤j, Ni is an integer greater than or equal to 2. For each level of computing module group from the first level to the jth level, the number of input/output interfaces used for communication interconnection within the computing module group at that level is greater than the number of input/output interfaces used for communication interconnection between different computing module groups at that level.

In some embodiments, the number of input/output interfaces used for communication interconnection among the computing modules within the first-level computing module group is greater than the number of input/output interfaces used for communication interconnection among the first-level computing module groups within the second-level computing module group.

In some embodiments, the number of input/output interfaces used for communication interconnection among the (i−1)th-level computing module groups within the ith-level computing module group is greater than the number of input/output interfaces used for communication interconnection among the ith-level computing module groups within the (i+1)th-level computing module group, where i<j.

In some embodiments, the number of input/output interfaces of each computing module used for the computing module groups from the first level to the jth level equals K.

In some embodiments, in at least one level of computing module groups among the first level to the jth level, the links used for communication interconnection within that level are optical links.

In some embodiments, the plurality of computing modules form two levels of computing module groups, such that j=2. Every 4 or 6 computing modules form the first-level computing module group, such that N1=4 or 6. The ith link is a second link, and the second link is an optical link.

In some embodiments, the computing modules within the first-level computing module group are arranged along a first plane, and the first-level computing module groups within the second-level computing module group are arranged along the first plane or along a second plane perpendicular to the first plane.

In some embodiments, N1=4, such that every four computing modules form the first-level computing module group. Within the second-level computing module group, N2 first-level computing module groups form a ring topology, where N2≥4.

In some embodiments, K=8, M1=6, the four computing modules within the first-level computing module group are directly connected to each other through first links, and each pair of computing modules communicates through two input/output interfaces.

In some embodiments, K=5, M1=3, the four computing modules within the first-level computing module group are directly connected to each other through first links, and each pair of computing modules communicates through one input/output interface.

In some embodiments, the plurality of computing modules form three levels of computing module groups, such that j=3. Every 4 or 6 computing modules form the first-level computing module group, such that N1=4 or 6. Second links are used for communication interconnection within the second-level computing module group and third links are used for communication interconnection within the third-level computing module group, wherein the second links are electrical links or optical links, and the third links are optical links.

In some embodiments, the first-level computing module groups, the second-level computing module groups, and the third-level computing module groups are each arranged in a respective plane within their corresponding levels, and the respective levels are arranged relative to one another to define a three-dimensional structure.

In some embodiments, every two computing modules within the first level are directly connected by a communication channel.

In some embodiments, every two computing modules within the second level are connected by a communication channel with a maximum hop count of 2.

In some embodiments, every two computing modules within the third level are connected by a communication channel with a maximum hop count of 3.

In some embodiments, each computing module comprises a computing chip and a plurality of optical modules. The computing chip has a plurality of electrical input/output interfaces, each optical module includes electrical input/output interfaces and optical input/output interfaces. At least a portion of the electrical input/output interfaces of the computing chip are directly electrically connected to the electrical input/output interfaces of the optical modules, wherein the number of optical modules is less than or equal to K.

In some embodiments, each computing module further includes a printed circuit board (PCB), and at least a portion of the electrical input/output interfaces of the computing chip are electrically connected to the electrical input/output interfaces of the optical modules through wiring on the PCB.

In some embodiments, the electrical input/output interfaces of the computing chip are SerDes interfaces, which include a serializer and a deserializer.

In some embodiments, the electrical input/output interfaces of the computing chip are PCIe physical interfaces, such that the computing chip is configured to provide PCIe electrical signals to the optical modules to drive the optical modules.

In some embodiments, the system further comprises a slot disposed on the PCB, wherein the optical modules are detachably received in the slot.

In some embodiments, each computing module includes a computing chip and a HBM memory chip.

In some embodiments, the optical link is an active optical cable, with optical modules provided at both ends of the active optical cable. The computing module includes a PCB on which a computing chip is disposed. The active optical cable is detachably connected to the electrical input/output interfaces of the computing chip. The electrical input/output interfaces of the computing chip are PCIe physical interfaces or SerDes interfaces.

In another aspect, a computing system is provided, which includes the interconnection system according to any one of the embodiments of the present disclosure.

As described above, in the interconnection system according to the embodiments of the present disclosure, a plurality of computing modules are grouped to form first-level computing module groups, a plurality of first-level computing module groups form second-level computing module groups, and additional higher-level computing module groups may be formed in a similar hierarchical manner, thereby establishing two or more levels of computing module groups. Increasing communication bandwidth generally reduces communication latency. In particular, increasing the interconnection bandwidth within a computing module group at a given level can significantly reduce latency, whereas increasing the interconnection bandwidth between computing module groups at that level typically yields only limited latency improvement. Because communication bandwidth is constrained by the number of available input/output interfaces, the interconnection system is configured such that the number of input/output interfaces used for communication interconnection within a computing module group at a given level is greater than the number of input/output interfaces used for communication interconnection between computing module groups at that level (i.e., within a higher-level computing module group formed by those computing module groups).

For example, the number of input/output interfaces used for interconnection within a first-level computing module group is greater than the number used for interconnection between different first-level computing module groups (which form a second-level computing module group). Similarly, the number used within a second-level computing module group is greater than the number used between different second-level computing module groups (which form a third-level computing module group), and so on. In this manner, the limitation imposed by the number of interfaces available at a single computing node (computing module) can be alleviated, enabling the overall computing scale to be flexibly expanded according to system requirements, thereby meeting the demands for high computational capability and high bandwidth.

In addition, in the above embodiments, at least a portion of the interconnection links are implemented as optical links. Optical interconnection can reduce power consumption and latency, thereby facilitating large-scale expansion of computing modules and improving overall communication capability. Meanwhile, electrical links may still be used for communication between computing modules located in close proximity. Accordingly, the interconnection system provides flexible configuration options, allowing system cost and performance to be balanced according to application requirements.

Various aspects, features, and advantages of the embodiments of the present disclosure will be described in further detail below with reference to the accompanying drawings.

### BRIEF DESCRIPTION OF THE DRAWINGS

FIG. 1 is a schematic diagram illustrating a topology of an interconnection system according to Embodiment 1 of the present disclosure.

FIG. 2 is a schematic diagram illustrating a topology of an interconnection system according to Embodiment 2 of the present disclosure.

FIG. 3 is a schematic diagram illustrating a topology of an interconnection system according to Embodiment 3 of the present disclosure.

FIG. 4 is a schematic diagram illustrating a topology of an interconnection system according to Embodiment 4 of the present disclosure.

FIGS. 5A and 5B illustrate an example of a computing module according to an embodiment of the present disclosure, wherein FIG. 5A is a top view showing an example configuration of the computing module, and FIG. 5B is a cross-sectional view showing an example configuration of the computing module.

FIG. 6 is a side view showing an example structural of a computing module comprising a PCIe interface.

### DETAILED DESCRIPTION OF THE INVENTION

Exemplary embodiments of the present disclosure will be described in greater detail below with reference to the accompanying drawings. It should be understood that the present disclosure may be embodied in various forms and should not be construed as being limited to the embodiments described herein. Rather, these embodiments are provided so that the disclosure will be thorough and complete, and will fully convey the aspects and features of the present disclosure to those skilled in the art. Processes, elements, and techniques that are not necessary for a person of ordinary skill in the art to understand the aspects and features of the present disclosure may be omitted for the sake of clarity.

Unless otherwise indicated, like reference numerals refer to like elements throughout the drawings and the description, and therefore repeated descriptions thereof may be omitted. Furthermore, features or aspects described in connection with one exemplary embodiment may generally be applied to corresponding features or aspects of other exemplary embodiments.

The terminology used herein is for the purpose of describing particular embodiments only and is not intended to limit the present invention. As used herein, the singular forms “a,” “an,” and “the” are intended to include the plural forms as well, unless the context clearly indicates otherwise. It will also be understood that the terms “comprise,” “comprising,” “include,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the meanings commonly understood by a person of ordinary skill in the art to which the present disclosure pertains. It will also be understood that terms, such as those defined in commonly used dictionaries, should be interpreted as having meanings consistent with their meanings in the relevant art and in the context of the present specification, and should not be interpreted in an idealized or overly rigid sense.

Embodiments of the present disclosure generally relate to an interconnection system for a plurality of computing modules and to a computing system including the same. In some embodiments, a plurality of computing modules are grouped to form first-level computing module groups, a plurality of first-level computing module groups are further grouped to form second-level computing module groups, and additional higher-level computing module groups may be formed in a similar hierarchical manner, thereby enabling the construction of two or more hierarchical levels of computing module groups. At each level,, the number of input/output interfaces used for communication interconnection within a computing module group is greater than the number of input/output interfaces used for communication interconnection between different computing module groups at that level.

In some embodiments, the interconnection system includes a plurality of computing modules, each computing module having K input/output interfaces, wherein K is an integer greater than 0. The plurality of computing modules are hierarchically organized into j levels of computing module groups, wherein j is an integer greater than or equal to 2. At a first level, every N1 computing modules form a first-level computing module group, and M1 input/output interfaces of each computing module are used for communication interconnection among the computing modules within the first-level computing module group. The computing modules within each first-level computing module group are communicatively interconnected through first links, wherein N1 is an even integer greater than or equal to 2. At higher levels, every Ni computing module groups of the (i−1)th-level form an ith-level computing module group, and Mi input/output interfaces of each (i−1)th-level computing module group are used for communication interconnection among the (i−1)th-level computing module groups within the ith-level computing module group. The (i−1)th-level computing module groups within the ith-level computing module group are communicatively interconnected through ith links, wherein i denotes a level index satisfying 1<i≤j, Ni is an integer greater than or equal to 2. For each level from the first level to the jth level, the number of input/output interfaces used for communication interconnection within the computing module group at that level is greater than the number of input/output interfaces used for communication interconnection between different computing module groups at that level.

### Embodiment 1

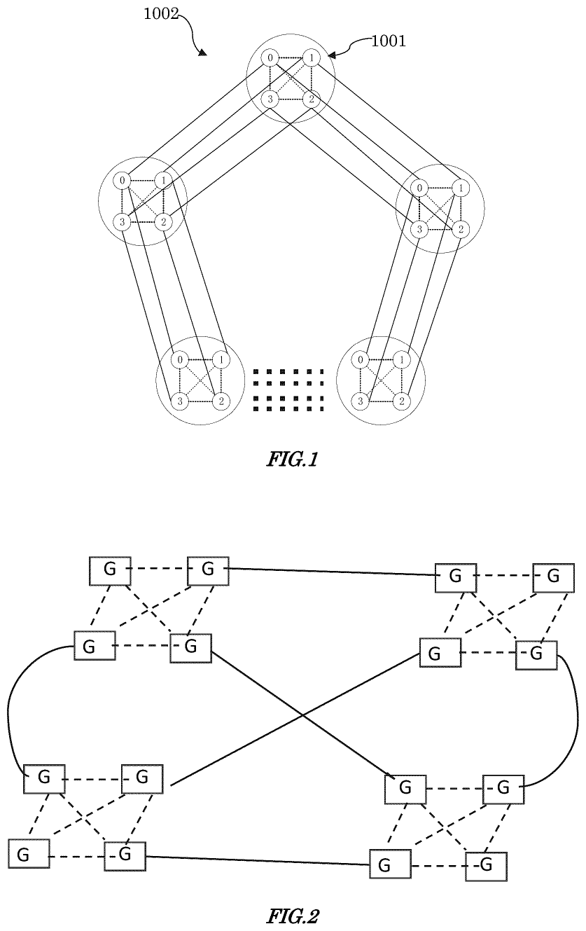

FIG. 1 illustrates a topology of an interconnection system according to Embodiment 1 of the present disclosure. The interconnection system includes a plurality of computing modules (e.g., XPU, each representing a type of processing unit). In an illustrative example, each computing module is provided with eight input/output interfaces (i.e., K=8). The plurality of computing modules forms two hierarchical levels of computing module groups, including a first-level computing module group 1001 and a second-level computing module group 1002.

In this interconnection system, every four computing modules form one first-level computing module group 1001 (i.e., N₁₌₄). As shown in FIG. 1, each first-level computing module group includes computing module 0, computing module 1, computing module 2, and computing module 3. Six input/output interfaces (i.e., M₁=6) of each computing module are used for communication interconnection among computing modules within the first-level computing module group. Specifically, computing module 0, computing module 1, computing module 2, and computing module 3 are interconnected in a pairwise manner via first-level links (illustrated as dashed lines in the figure). The interconnection between computing module 0 and computing module 1 uses two input/output interfaces of both modules; the interconnection between computing module 0 and computing module 2 uses two input/output interfaces of both modules; and the interconnection between computing module 0 and computing module 3 uses two input/output interfaces of both modules, thereby enabling bidirectional 64 Gb/s interconnection channels among the computing modules within the first-level computing module group. The first-level links may be optical links or electrical links. In an exemplary embodiment, because the communication distance between computing modules within the first level is relatively short (typically less than 1 meter), the first-level links may be selected to be either electrical links or optical links as needed.

Furthermore, in this interconnection system, N₂ first-level computing module groups are connected via second-level links (illustrated as solid lines in the figure) to form a ring topology, thereby constructing the second-level computing module group 1002. In this configuration, each computing module reserves two input/output interfaces for communication interconnection between first-level computing module groups. Accordingly, the eight input/output interfaces of each first-level computing module group 1001 are used for communication interconnection among computing module groups within the second-level computing module group (i.e., M₂=8). Illustratively, one input/output interface of computing module 0 in a given first-level computing module group is connected via a second-level link to one input/output interface of computing module 0 in an upstream adjacent first-level computing module group, while another input/output interface is connected via a second-level link to one input/output interface of computing module 0 in a downstream adjacent first-level computing module group. Similarly, computing modules 1, 2, and 3 in adjacent first-level computing module groups are interconnected with corresponding modules, thereby forming bidirectional 32 Gb/s interconnection channels between computing modules belonging to different first-level computing module groups. In other words, the first-level computing module groups within the second-level computing module group are interconnected through bidirectional 32 Gb/s communication channels. The second-level links may be electrical links or optical links. N₂ may be any integer greater than 3, preferably 4≤N_{2≤16}. When the distance between interconnected computing modules exceeds approximately 1 meter, signal integrity may degrade and latency may increase. Optical interconnection can mitigate these drawbacks, thus the second-level links are preferably optical links.

In Embodiment 1, six input/output interfaces of each computing module are used for interconnection within the first-level computing module group, while two input/output interfaces are used for interconnection between first-level computing module groups. In other words, the number of input/output interfaces used for communication interconnection within the first-level computing module group is greater than the number used for communication interconnection between different first-level computing module groups (i.e., within the second-level computing module group). Increasing communication bandwidth generally reduces latency. In the present embodiment, increasing interconnection bandwidth within a first-level computing module group significantly reduces latency, whereas increasing interconnection bandwidth between first-level computing module groups does not significantly reduce latency. Accordingly, by allocating more input/output interfaces for communication interconnection within a computing module group than for communication interconnection between different computing module groups, the system can expand the number of computing modules to increase computational power while simultaneously increasing bandwidth and reducing latency, despite the limited number of input/output interfaces.

Although in Embodiment 1 every four computing modules form a first-level computing module group (i.e., N₁=4), it should be understood that in some implementations every six computing modules may form a first-level computing module group (i.e., N₁=6).

In some embodiments, the computing modules within the first-level computing module group are arranged along a first plane, and the first-level computing module groups within the second-level computing module group are arranged along the first plane or along a second plane perpendicular to the first plane.

In some embodiments, at least one of the first-level links and the second-level links is an optical link using optical input/output interfaces.

In some embodiments, the total number of input/output interfaces of each computing module used for interconnection within the first-level and second-level computing module groups equals eight. In other words, all input/output interfaces are utilized to the greatest extent possible to achieve maximum communication bandwidth while simultaneously expanding the scale of computing modules to increase computational capacity.

In Embodiment 1, K=8 and M₁=6, and the four computing modules within the first-level computing module group are directly interconnected by first-level links such that each pair of computing modules communicates via two input/output interfaces. The present disclosure is not limited thereto. In an alternative implementation, K=5 and M₁=3, and the four computing modules within the first-level computing module group are directly interconnected by first-level links such that each pair of computing modules communicates via one input/output interface.

### Embodiment 2

FIG. 2 illustrates a topology of an interconnection system according to Embodiment 2 of the present disclosure. While Embodiment 1 describes a two-level interconnection system where each computing module has eight input/output interfaces, the present disclosure is not limited thereto. Each computing module may have four, five, six, seven, eight, or more input/output interfaces. In Embodiment 2, a configuration in which K=4 (i.e., each computing module has four input/output interfaces) is provided as an illustrative example of a two-level interconnection system.

In Embodiment 2, the interconnection system includes sixteen computing modules G (e.g., GPUs), each having four input/output interfaces. At the first level, every four computing modules G (i.e., N₁=4) form a first-level computing module group, thereby resulting in four first-level computing module groups. Within each first-level computing module group, the four computing modules G are interconnected pairwise manner via first-level links (shown as dashed lines in FIG. 2), with each computing module using three input/output interfaces for intra-group communication. Consequently, each first-level computing module group utilizes twelve input/output interfaces for intra-group interconnection and reserve four input/output interfaces for interconnection with other groups. At the second level, the four first-level computing module groups communicate and interconnect in pairwise manner. Specifically, each first-level computing module group is connected to the other three first-level computing module groups via second-level links (shown as solid lines in FIG. 2), using three input/output interfaces in total. Accordingly, for each computing module G, three input/output interfaces are used for intra-first-level group communication, and one input/output interface is available for inter-first-level group communication. That is, the number of input/output interfaces used for communication interconnection within a computing module group is greater than the number used for communication interconnection between computing module groups.

At least one of the first-level links or second-level links is an optical link. Preferably, the first-level links are electrical links, and the second-level links are optical links. In alternative embodiments, both the first-level links and the second-level links may be optical links.

It should be understood that, according to the principles of the present disclosure, a plurality of computing modules may be organized into more than two levels of computing module groups. For example, third-level computing module groups can be formed using second-level computing module groups as units; fourth-level computing module groups can be formed using third-level computing module groups as units; and so on. For any level of computing module group, the number of input/output interfaces used for communication interconnection within the group is greater than the number used for interconnection between different computing module groups at that level.

### Embodiment 3

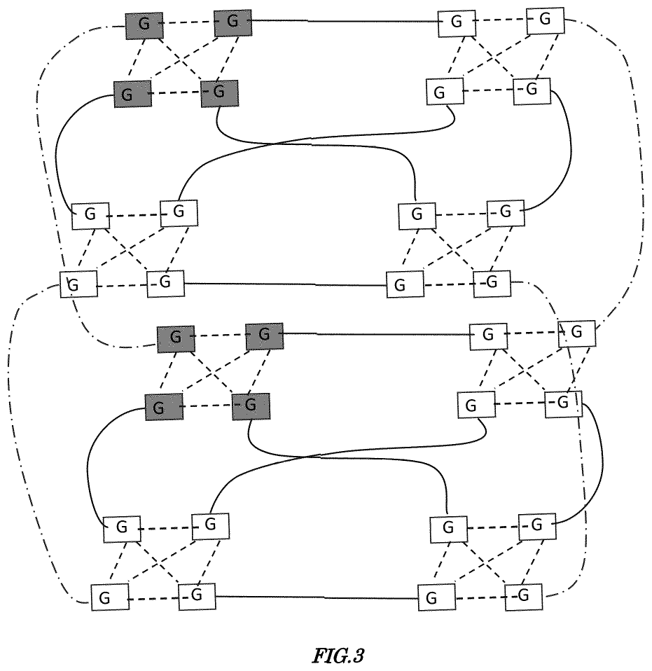

FIG. 3 illustrates a topology of an interconnection system according to Embodiment 3 of the present disclosure. In Embodiment 3, the second-level computing module groups of Embodiment 2 are treated as units, and two second-level computing module groups are interconnected via third-level links to form a third-level computing module group. Thus, Embodiment 3 employs thirty-two computing modules to establish three levels of computing module groups.

As in Embodiment 2, every four computing modules G form a first-level computing module group, thereby resulting in eight first-level computing module groups. First-level computing module groups are communicatively interconnected using first-level links. Every four first-level computing module groups form a second-level computing module group, thereby resulting in two second-level computing module groups. The first-level computing module groups within each second-level computing module group are communicatively interconnected via second-level links. The two second-level computing module groups are communicatively interconnected via third-level links (shown as dash-dot lines in FIG. 3), thereby forming a third-level computing module group.

Each computing module G has four input/output interfaces, of which three are used for communication interconnection within the first-level computing module group, and one is used for communication interconnection outside the first-level computing module group. Thus, each first-level computing module group has four input/output interfaces for external communication interconnection, of which three input/output interfaces are used for communication interconnection among the first-level computing module groups within the second-level computing module group, and one is used for communication interconnection outside the second-level computing module group. Since each second-level computing module group includes four first-level computing module groups, each second-level computing module group has four input/output interfaces for external communication interconnection. These four interfaces are interconnected via four third-level links. Accordingly, in this interconnection system, each first-level computing module group can have twelve input/output interfaces for intra-group communication and three input/output interfaces for interconnection among the four first-level computing module groups within a second-level computing module group. Each second-level computing module group can have twelve input/output interfaces for interconnection among the four first-level computing module groups and four input/output interfaces for interconnection between the two second-level computing module groups within the third-level computing module group. Compared with Embodiment 2, in which four input/output interfaces remain unused, in Embodiment 3 all input/output interfaces of all computing modules are fully utilized. By constructing multiple hierarchical levels, the computing cluster can achieve maximum communication bandwidth and computational capacity.

In some embodiments, at least one of the first-level links, the second-level links, or the third-level links is an optical link. Preferably, the third-level links are optical links. More preferably, both the second-level links and third-level links are optical links.

In some embodiments, the first-level, second-level, and third-level computing module groups are each arranged in a planar configuration within their respective levels, and the respective levels are arranged relative to one another to define a three-dimensional structure.

### Embodiment 4

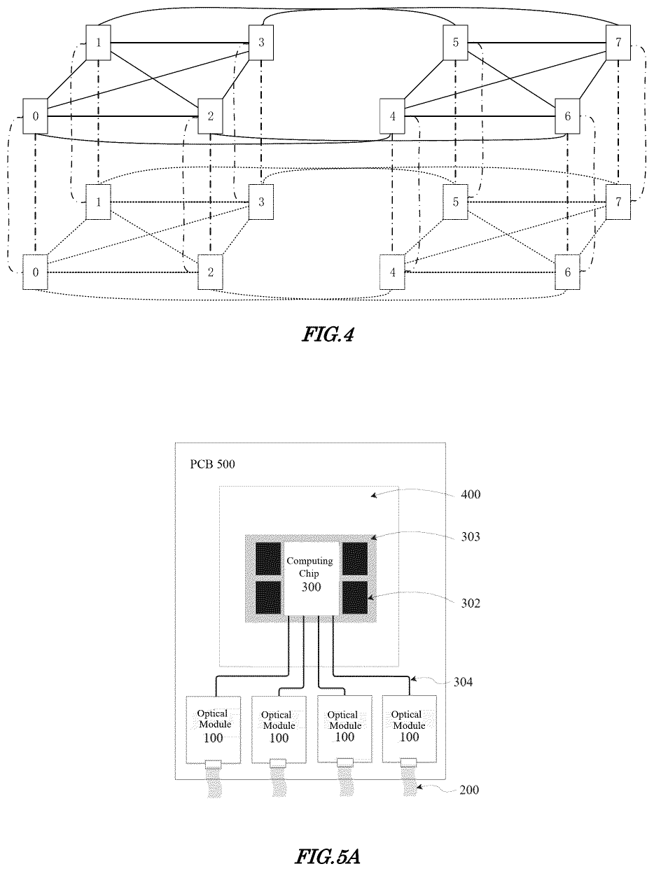

FIG. 4 illustrates a topology of an interconnection system according to Embodiment 4 of the present disclosure. In Embodiment 4, the interconnection system includes sixteen computing modules, each having six input/output interfaces. Every four computing modules form a first-level computing module group, thereby resulting in four first-level computing module groups. For example, computing modules 0, 1, 2, and 3 within the solid-line box form one first-level computing module group; computing modules 4, 5, 6, and 7 form another first-level computing module group; computing modules 0, 1, 2, and 3 within the dashed-line box form a further first-level computing module group; and computing modules 4, 5, 6, and 7 form yet another first-level computing module group. Three input/output interfaces of each computing module are used for intra-first-level group communication via first-level links, and the remaining three input/output interfaces are available for inter-group communication. Accordingly, each first-level computing module group has twelve input/output interfaces available for external communication interconnection.

Every two first-level computing module groups form a second-level computing module group. For example, the first-level computing module group including computing modules 0, 1, 2, 3 within the solid-line box and the first-level computing module group including computing modules 0, 1, 2, 3 within the dashed-line box are interconnected via second-level links to form a second-level computing module group. Similarly, the first-level computing module groups including computing modules 4, 5, 6, 7 form another second-level computing module group. These two second-level computing module groups are interconnected via third-level links to form a third-level computing module group.

Thus, each first-level computing module group has twelve input/output interfaces for external communication interconnection. Of these, eight input/output interfaces are used for interconnection between the two first-level computing module groups within a second-level computing module group via second-level links (shown as dash-dot lines), and the remaining four input/output interfaces are used for interconnection between the two second-level computing module groups within the third-level computing module group via third-level links. Accordingly, each first-level computing module group can utilize twelve interfaces for intra-group communication and eight interfaces for interconnection with other first-level computing module groups within a second-level computing module group. Each second-level computing module group can utilize sixteen interfaces for interconnection among the two first-level computing module groups within the second-level computing module group, and eight interfaces for interconnection between the two second-level computing module groups within the third-level computing module group. In this configuration, any two computing modules within a first-level group have a direct one-hop communication path; any two computing modules within a second-level group have a communication path with a maximum of two hops; and any two computing modules within a third-level group have a communication path with a maximum of three hops.

In some embodiments, at least one of the first-level, second-level, or third-level links is an optical link. Preferably, the third-level links are optical links. More preferably, both the second-level and third-level links are optical links. This topology enables high communication bandwidth and low latency.

In certain implementations, the interconnection system of the present disclosure may further include fourth-level, fifth-level, or additional higher-level computing module groups, as required.

### Computing Module

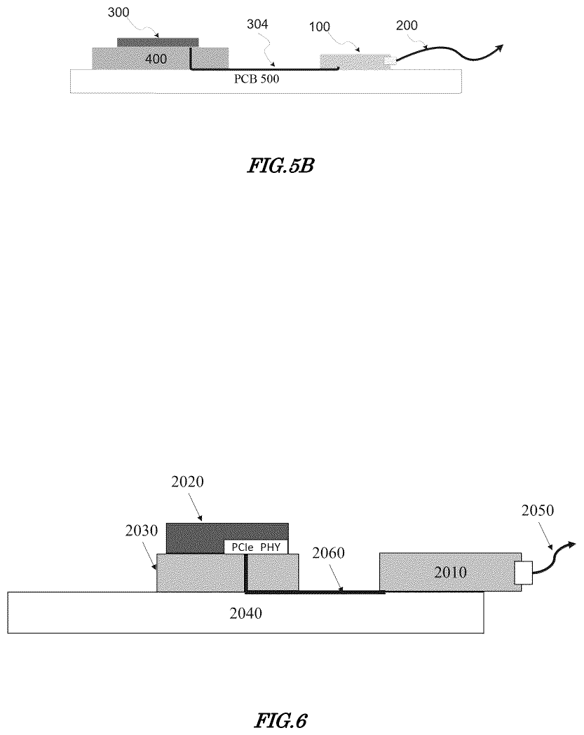

In some embodiments, a computing module in the interconnection system of the present disclosure includes a computing chip and one or more optical modules. FIGS. 5A and 5B illustrate an exemplary computing module according to an embodiment of the present disclosure, in which FIG. 5A shows a top view of an example configuration of the computing module, and FIG. 5B shows a cross-sectional view of the example configuration.

As illustrated in FIGS. 5A and 5B, the computing module includes one or more optical modules 100 and a computing chip 300. The optical modules 100 and the computing chip 300 are disposed on the same printed circuit board (PCB) 500.

Each optical module 100 includes multiple electrical input/output (I/O) interfaces and optical I/O interfaces. In some embodiments, the number of optical modules 100 is less than or equal to the number of electrical I/O interfaces.

The computing chip 300 and the optical modules 100 are arranged on the same PCB 500, and the computing chip 300 includes one or more high-speed I/O interfaces (e.g., long-reach SerDes interfaces). For illustrative purposes, FIG. 5A schematically shows four high-speed I/O interfaces of the computing chip 300 connected to the optical modules (e.g., via wiring 304). When electrical links are used for interconnections between computing modules in the interconnection system, the computing chip 300 may include additional high-speed I/O interfaces not connected to the optical modules, which are reserved for electrical interconnection. Optionally, the computing chip 300 may be mounted on the PCB 500 via a substrate 400.

In some embodiments, the computing chip 300 may be an artificial intelligence chip, including but not limited to a Graphics Processing Unit (GPU), a Neural Processing Unit (NPU), a Tensor Processing Unit (TPU), an Intelligence Processing Unit (IPU), a Deep Learning Processing Unit (DPU), etc.

It should be noted that the illustration of only four high-speed I/O interfaces of the computing chip 300 corresponding to four optical modules is provided for ease of description. In practical applications, any number of high-speed I/O interfaces can be provided on the computing chip 300 depending on specific design requirements. In an embodiment, each high-speed I/O interface of the computing chip 300 converts parallel signals within the computing chip into a first electrical signal (not shown in the figures) via parallel-to-serial conversion, which is then provided to the corresponding electrical input port of the associated optical module 100 for electro-optical conversion. Such parallel-to-serial conversion may be performed by a serializer circuit within the SerDes interface, thereby converting multiple low-speed parallel signals from the computing chip 300 into a high-speed serial signal.

Conversely, each high-speed I/O interface of the computing chip 300 receives a second electrical signal as a high-speed serial signal from the optical module 100 and converts the high-speed serial signal into low-speed parallel signals via serial-to-parallel conversion (not shown), such that the computing chip 300 can process the signals. Such serial-to-parallel conversion may be performed by a deserializer circuit within the SerDes interface, thereby converting high-speed serial signals into low-speed parallel signals.

It should be understood that the wiring 304 on PCB 500 generally represents electrical connections between the optical modules 100 and the computing chip 300 and is not intended to indicate any specific wiring configuration.

Functionally, each optical module 100 is configured to perform electro-optical (E-O) conversion and opto-electrical (O-E) conversion.

The computing module 3000 may further include at least one high-bandwidth memory (HBM) unit 302. For example, the HBM unit 302 can cooperate with the computing chip 300 to perform various caching or storage functions.

In some embodiments, multiple HBM units 302 may be arranged together with the computing chip 300 on substrate 400. Optionally, the multiple HBM units 302 may be disposed on opposite sides of the computing chip 300.

In some embodiments, the electrical I/O interfaces on the computing chip may be PCIe physical interfaces. The computing chip provides PCIe electrical signals to the optical modules, and the PCIe electrical signals are used to drive the optical modules. FIG. 6 is a side view showing a structural example of a computing module having a PCIe interface. In an embodiment, the computing chip is configured with a PCIe physical interface, also known as a PCIe PHY interface. The PCIe PHY interface is used to perform protocol conversion on I/O signals of the computing chip, thereby enabling the signals to comply with the PCIe standard.

In the embodiment shown in FIG. 6, the PCIe PHY interface on the computing chip 2020 is configured to convert digital signals of the computing chip into PCIe electrical signals. These PCIe electrical signals can be directly fed to the electrical input interface of the PCIe optical module 2010 for electro-optical (E-O) conversion.

Furthermore, PCIe electrical signals output from the electrical output interface after opto-electrical (O-E) conversion by the PCIe optical module 2010 may also be directly fed to the PCIe PHY interface of the computing chip 2020. The PCIe PHY interface then converts the PCIe electrical signals into digital signals for use by the computing chip 2020.

In some embodiments, the PCB 2040 may include slots (not shown) disposed near its center or along edges thereof, and the optical module 2010 may be detachably mounted into the slots.

The computing chip 2020 is disposed on a package substrate 2030, which is disposed on the PCB 2040.

Electrical interconnections between the computing chip 2020 and optical module 2010 are provided via wiring 2060 in the package substrate 2030 and PCB 2040.

For example, the edge of PCB 2040 may correspond to a front panel of a server device, allowing optical modules 2010 to be plugged or unplugged from the front panel, thereby minimizing interference with other components.

Moreover, in the configuration shown in FIG. 6, the computing chip 2020 may be placed as close as possible to the optical module 2010 to reduce the length of wiring 2060, thereby improving signal integrity.

Additionally, appropriate wiring 2060 can be provided for various data signals and control signals, enabling the optical module 2010 to convert electrical signals from the computing chip 2020 to optical signals for transmission via an optical fiber array 2050, as illustrated.

In another embodiment, the optical module 2010 is fixedly mounted in a first region of the PCB 2040 rather than being pluggable as shown in FIG. 6. The computing chip 2020 is disposed on the package substrate 2030, and the package substrate 2030 is arranged in a second region of the PCB board 2040 different from the first region mentioned above, such that the package substrate 2030 and the optical module 2010 are not arranged in an overlapping manner.

In some embodiments, the optical link may include an active optical cable with optical modules at both ends thereof. The computing module includes a PCB and a computing chip disposed thereon, and the active optical cable is detachably connected to the electrical I/O interfaces of the computing chip, which may be PCIe PHY interfaces or SerDes interfaces.

Based on the foregoing, those skilled in the art should understand that embodiments of the computing system of the present disclosure include the interconnection system described in any one of the foregoing implementations or embodiments.

Those skilled in the art should understand that the above disclosure merely describes exemplary embodiments of the present disclosure and is not intended to limit the scope of the patent protection sought. Any modifications or equivalent arrangements made in accordance with the teachings of the present disclosure shall fall within the scope of the claims of the present application.

1. An interconnection system, comprising a plurality of computing modules, each computing module having K input/output interfaces, wherein K is an integer greater than 0;
the plurality of computing modules being hierarchically organized into j levels of computing module groups, wherein j is an integer greater than or equal to 2;
wherein:
every N1 computing modules form a first-level computing module group, and M1 input/output interfaces of each computing module are used for communication interconnection among the computing modules within the first-level computing module group, the computing modules within the first-level computing module group being communicatively interconnected through first links, and N1 is an even integer greater than or equal to 2;
every N1 computing module groups of the (i−1)th-level form an ith-level computing module group, and Mi input/output interfaces of each (i−1)th-level computing module group are used for communication interconnection among the (i−1)th-level computing module groups within the ith-level computing module group, the (i−1)th-level computing module groups within the ith-level computing module group being communicatively interconnected through ith links, where i denotes a level index satisfying 1<i≤j, Ni is an integer greater than or equal to 2; and
for each level of computing module group from the first level to the jth level, the number of input/output interfaces used for communication interconnection within the computing module group at that level is greater than the number of input/output interfaces used for communication interconnection between different computing module groups at that level.

2. The interconnection system according to claim 1, wherein the number of input/output interfaces used for communication interconnection among the computing modules within the first-level computing module group is greater than the number of input/output interfaces used for communication interconnection among the first-level computing module groups within the second-level computing module group.

3. The interconnection system according to claim 1, wherein the number of input/output interfaces used for communication interconnection among the (i−1)th-level computing module groups within the ith-level computing module group is greater than the number of input/output interfaces used for communication interconnection among the ith-level computing module groups within the (i+1)th-level computing module group, where i<j.

4. The interconnection system according to claim 1, wherein the number of input/output interfaces of each computing module used for the computing module groups from the first level to the jth level equals K.

5. The interconnection system according to claim 1, wherein in at least one level of computing module groups among the first level to the jth level, the links used for communication interconnection within that level are optical links.

6. The interconnection system according to claim 1, wherein
the plurality of computing modules form two levels of computing module groups, such that j=2,
every 4 or 6 computing modules form the first-level computing module group, such that N1=4 or 6, and
the ith link is a second link, and the second link is an optical link.

7. The interconnection system according to claim 6, wherein
the computing modules within the first-level computing module group are arranged along a first plane, and
the first-level computing module groups within the second-level computing module group are arranged along the first plane or along a second plane perpendicular to the first plane.

8. The interconnection system according to claim 6, wherein:
N1=4, such that every four computing modules form the first-level computing module group, and
within the second-level computing module group, N2 first-level computing module groups form a ring topology, where N2≥4.

9. The interconnection system according to claim 8, wherein
K=8, M1=6,
the four computing modules within the first-level computing module group are directly connected to each other through first links, and
each pair of computing modules communicates through two input/output interfaces.

10. The interconnection system according to claim 8, wherein
K=5, M1=3,
the four computing modules within the first-level computing module group are directly connected to each other through first links, and
each pair of computing modules communicates through one input/output interface.

11. The interconnection system according to claim 1, wherein the plurality of computing modules form three levels of computing module groups, such that j=3,
every 4 or 6 computing modules form the first-level computing module group, such that N1=4 or 6,
second links are used for communication interconnection within the second-level computing module group, and third links are used for communication interconnection within the third-level computing module group,
wherein the second links are electrical links or optical links, and the third links are optical links.

12. The interconnection system according to claim 11, wherein
the first-level computing module groups, the second-level computing module groups, and the third-level computing module groups are each arranged in a respective plane within their corresponding levels, and the respective levels are arranged relative to one another to define a three-dimensional structure.

13. The interconnection system according to claim 1, wherein
every two computing modules within the first level are directly connected by a communication channel.

14. The interconnection system according to claim 13, wherein
every two computing modules within the second level are connected by a communication channel with a maximum hop count of 2.

15. The interconnection system according to claim 14, wherein
every two computing modules within the third level are connected by a communication channel with a maximum hop count of 3.

16. The interconnection system according to claim 5, wherein
each computing module comprises a computing chip and a plurality of optical modules,
the computing chip has a plurality of electrical input/output interfaces,
each optical module comprises electrical input/output interfaces and optical input/output interfaces, and
at least a portion of the electrical input/output interfaces of the computing chip are directly electrically connected to the electrical input/output interfaces of the optical modules,
wherein the number of optical modules is less than or equal to K.

17. The interconnection system according to claim 16, wherein:
each computing module further comprises a printed circuit board (PCB); and
at least a portion of the electrical input/output interfaces of the computing chip are electrically connected to the electrical input/output interfaces of the optical modules through wiring on the PCB.

18. The interconnection system according to claim 17, wherein
the electrical input/output interfaces of the computing chip are SerDes interfaces.

19. The interconnection system according to claim 17, wherein
the electrical input/output interfaces of the computing chip are PCIe physical interfaces, such that the computing chip is configured to provide PCIe electrical signals to the optical modules to drive the optical modules.

20. The interconnection system according to claim 19, further comprising a slot disposed on the PCB, wherein the optical modules are detachably received in the slot.

21. (canceled)

22. The interconnection system according to claim 5, wherein
the optical link is an active optical cable, with optical modules provided at both ends of the active optical cable;
the computing module comprises a PCB on which a computing chip is disposed; and
the active optical cable is detachably connected to the electrical input/output interfaces of the computing chip.

23. (canceled)
